(19) United States
(12) Patent Application Publication
(10) Pub. No.: US 2014/0164738 A1
(43) Pub. Date: Jun. 12, 2014

(54) INSTRUCTION CATEGORIZATION FOR RUNAHEAD OPERATION

(71) Applicant: NVIDIA CORPORATION, Santa Clara, CA (US)

(72) Inventors: Magnus Ekman, Alameda, CA (US); Guillermo J. Rozas, Los Gatos, CA (US); Alexander Klaiber, Mountain View, CA (US); James van Zoeren, Albuquerque, NM (US); Paul Serris, San Jose, CA (US); Brad Hoyt, Portland, OR (US); Sridharan Ramakrishnan, Hillsboro, OR (US); Hens Vanderschoot, Tigard, OR (US); Ross Segelken, Portland, OR (US); Darrell D. Boggs, Aloha, OR (US)

(73) Assignee: NVIDIA Corporation, Santa Clara, CA (US)

(21) Appl. No.: 13/708,544

(22) Filed: Dec. 7, 2012

(51) Int. Cl. G06F 9/30

(52) U.S. Cl. CPC G06F 9/30
USPC 712/205; 712/229

(57) ABSTRACT

Embodiments related to methods and devices operative, in the event that execution of an instruction produces a runahead-triggering event, to cause a microprocessor to enter into and operate in a runahead without reissuing the instruction are provided. In one example, a microprocessor is provided. The example microprocessor includes fetch logic for retrieving an instruction, scheduling logic for issuing the instruction retrieved by the fetch logic for execution, and runahead control logic. The example runahead control logic is operative, in the event that execution of the instruction as scheduled by the scheduling logic produces a runahead-triggering event, to cause the microprocessor to enter into and operate in a runahead mode without reissuing the instruction, and carry out runahead policies while the microprocessor is in the runahead mode that governs operation of the microprocessor and cause the microprocessor to operate differently than when not in the runahead mode.

### BACKGROUND

Instructions in microprocessors are often re-dispatched for execution one or more times due to pipeline errors or data hazards. For example, an instruction may need to be re-dispatched when an instruction refers to a result that has not yet been calculated or retrieved. A miss resulting from the unavailable information may cause the microprocessor to stall. Because it is not known whether other unpredicted stalls will arise due to other misses during resolution of that miss, the microprocessor may perform a runahead operation configured to detect other misses while the initial miss is being resolved.

### BRIEF DESCRIPTION OF THE DRAWINGS

FIG. 1 schematically shows a microprocessor of a computing device according to an embodiment of the present disclosure.

FIG. 2A shows a portion of a method of executing a microprocessor in runahead without reissuing an instruction that caused the microprocessor to enter runahead according to an embodiment of the present disclosure.

FIG. 2B shows another portion of the method shown in FIG. 2A.

FIG. 3A schematically shows, according to an embodiment of the present disclosure, a microprocessor pipeline upon detection of a runahead event.

FIG. 3B shows the microprocessor pipeline illustrated in FIG. 3A after entry into runahead.

### DETAILED DESCRIPTION

In modern microprocessors, architectural-level instructions are often executed in a pipeline. Such instructions may be issued individually or as bundles of micro-operations to various execution mechanisms in the pipeline. Regardless of the form that an instruction takes when issued for execution, when the instruction is issued, it is not known whether execution of the instruction will complete or not. Put another way, it is not known at dispatch whether a miss or an exception will arise during execution of the instruction.

A common pipeline execution stall that may arise during execution of an instruction is a load operation that results in a cache miss. Such cache misses may trigger an entrance into a runahead mode of operation (hereafter referred to as “runahead”) that is configured to detect, for example, other cache misses, instruction translation lookaside buffer misses, or branch mispredicts while the initial load miss is being resolved. As used herein, runahead describes any suitable speculative execution scheme resulting from a long-latency event, such as a cache miss where the resulting load event pulls the missing instruction or data from a slower access memory location. Once the initial load miss is resolved, the microprocessor exits runahead and the instruction is re-executed. Because other misses may arise, it is possible that an instruction may be re-executed several times prior to completion of the instruction.

Once the runahead-triggering event is detected, the state of the microprocessor (e.g., the registers and other suitable states) is checkpointed so that the microprocessor may return to that state after runahead. The microprocessor then continues executing in a working state during runahead. In some settings, the microprocessor may enter runahead immediately, and optionally may reissue the instruction that caused the microprocessor to enter runahead for execution. Because reissuing the instruction may take some time, the effective time that the microprocessor is able to detect new potential long latency events while in runahead may be reduced. In some other settings, such as a load miss, the microprocessor may delay entry into runahead until it can be determined whether a load miss in one cache can be satisfied by a hit in another cache in the memory hierarchy. For example, in a scenario where an instruction causes an L1 cache miss, the microprocessor may delay reissuing the instruction so that, once reissued, the instruction will line up with a hit from the L2 cache if it arrives. Put another way, in such a scenario the microprocessor will stall briefly, but does not immediately enter runahead, followed by a reissue of the instruction. Because the instruction may be reissued before it is known whether there will be a hit in the L2 cache, the microprocessor may still enter runahead if the L2 cache misses.

However, in each of the scenarios contemplated above, it is possible that an instruction may be launched without knowing whether a runahead-triggering event will result. Because some instructions may be treated differently in runahead mode than in normal mode, and because some of such differences may be applied at issuance, it can be difficult to enter runahead without reissuing the instruction that caused entry into runahead. For example, some microprocessor actions may adversely affect the microprocessor state if performed during runahead because those actions may lead to cache pollution and/or make return to the normal operating mode difficult.

Accordingly, the embodiments described herein relate to methods and hardware operative, in the event that execution of an instruction produces a runahead-triggering event, to cause a microprocessor to enter into and operate in a runahead mode without reissuing the instruction. In some examples, the embodiments described herein may carry out one or more runahead policies that govern operation of the microprocessor and cause the microprocessor to operate differently than when not in runahead while the microprocessor is in runahead. Put another way, the microprocessor may take different actions for some instructions depending on the runahead state.

For example, it will be appreciated that some actions may be prioritized differently during runahead relative to non-runahead operations, and/or that some actions may be viewed as being optional during runahead. Thus, in some embodiments, some actions may be categorized as being permissive, while other actions may be categorized being absolute.

A permissive action may be optional or reprioritized relative to another action. For example, a permissive action may be performed by the microprocessor to save power and/or enhance performance during runahead. Such alternative treatment may save processing time during runahead, as detection of an additional stall condition during runahead may be a more relevant result than a runahead calculation result, which may be invalid. In some embodiments, a permissive action may be applied to one or more instructions included in a permissive instruction category encountered during runahead though not necessarily to every instruction so-categorized that is encountered during runahead. Further, a permissive action may not be applied to an instruction included in a permissive instruction category issued prior to the detection of a runahead-triggering event.

In contrast, an absolute action may represent an action that enables proper runahead operation. Put another way, omitting or deprioritizing an absolute action may threaten proper runahead operation or return to normal operation after runahead. For example, an absolute action may include an action that preserves microprocessor correctness. As used herein, microprocessor correctness generally refers to the functional validity of the microprocessor's architectural state, so that an action that maintains the functional validity of the microprocessor's architecture maintains the correctness of the microprocessor. In some embodiments, an absolute action may be applied to every instruction included in an absolute instruction category encountered during runahead. Further, in some embodiments, an absolute action may be applied to an instruction included in an absolute instruction category issued prior to the detection of a runahead-triggering event. Applying absolute actions as described herein may preserve and protect the microprocessor's correctness.

In some settings, actions that affect microprocessor correctness may irretrievably alter the ability of the microprocessor to restart after runahead. As an example, in some embodiments, some registers of microprocessors may have a checkpointed copy from which the state that was present upon runahead entry can be recovered when restarting after a runahead episode. Since a checkpointed copy exists, writing to these registers during runahead may not interfere with restarting after runahead. However, some registers may not have a checkpointed copy. To preserve microprocessor functional correctness, writing to such registers during runahead should be avoided. Similar care may be applied to cache writes in the absence of cache protection mechanisms.

As another example, in some embodiments control registers may be included in a microprocessor that change and/or control the behavior/operation of the microprocessor's operation. In some of these settings, a change to a control register (e.g., via a write to that control register) may alter the microprocessor's behavior in a manner that is difficult to unwind at a later time. For example, a change to a control register made during runahead operation may introduce an operational change to the microprocessor that is difficult to undo, potentially causing post-runahead operation to proceed differently than would be expected had runahead not occurred. In some of such embodiments, the alteration of control registers may be prevented during runahead.

The absolute and permissive actions described above may be performed in response to respective runahead policies implemented at suitable stages of a multi-stage microprocessor pipeline so that runahead operation may commence without reissuing the runahead-triggering instruction. For example, a permissive runahead policy may be applied earlier in a multi-stage pipeline than is an absolute runahead policy on entry into runahead. In turn, optional actions may be applied to subsequently-issued instructions earlier in the pipeline, such as before entry to execution logic, as a result of permissive policy implementation on entry to runahead. Because these actions are optional, non-performance of those actions for instructions already in the execution logic because the instructions were not reissued on entry to runahead may be acceptable during runahead. Mandatory actions resulting from implementation of absolute runahead policies may be applied to all instructions in the execution logic at a later point in the pipeline. For example, applying absolute runahead policies at the exit from execution logic or at subsequent commitment or writeback logic so that all instructions potentially affected by runahead may be subjected to a suitable absolute runahead policy may avoid adverse alterations to microprocessor correctness.

In some examples, the disclosed embodiments may detect one or more instruction categories associated with instructions issued during runahead. In turn, one or more runahead policies related to a respective instruction category may be applied during runahead. Some embodiments may detect whether an instruction issued and/or executed during runahead is associated with an absolute instruction category and/or a permissive instruction category. In one scenario, an absolute runahead policy associated with an absolute instruction category may be applied before the instruction is committed. For example, potential corruption of the checkpointed state of the microprocessor from an improper writeback event during runahead may be prevented in a setting where microprocessor correctness may be affected by commitment of the instruction. In another scenario, a permissive runahead policy associated with a permissive instruction category may be applied before the instruction is issued and/or executed. If applied, a power/performance benefit may be realized by the microprocessor immediately upon issuance to the execution logic.

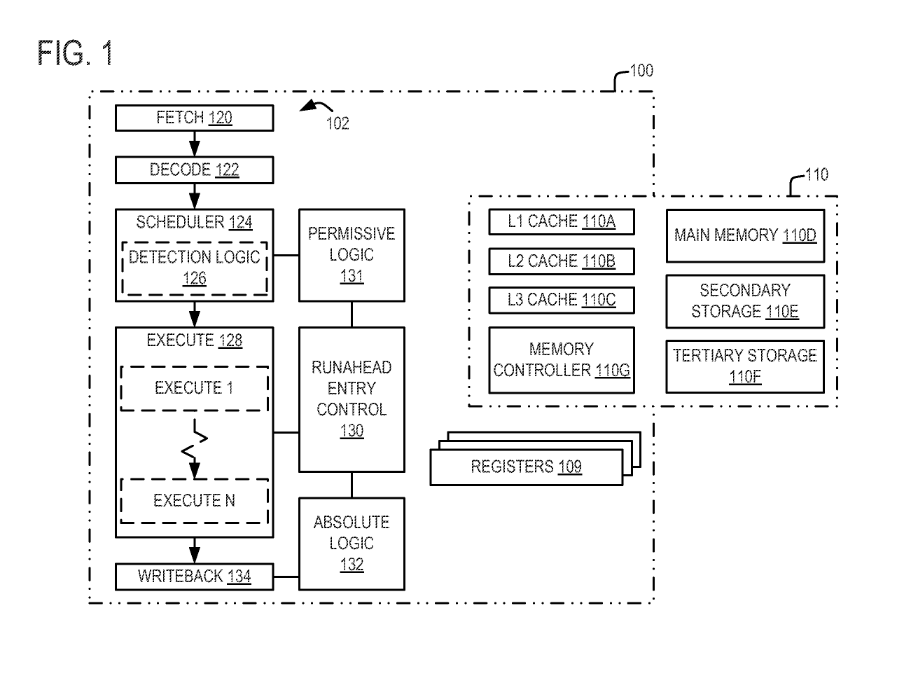

FIG. 1 schematically depicts an embodiment of a microprocessor 100 that may be employed in connection with the systems and methods described herein. Microprocessor 100 variously includes processor registers 109 and may also include a memory hierarchy 110, which may include an L1 processor cache 110A, an L2 processor cache 110B, an L3 processor cache 110C, main memory 110D (e.g., one or more DRAM chips), secondary storage 110E (e.g., solid-state, magnetic, and/or optical storage units) and/or tertiary storage 110F (e.g., a tape farm). It will be understood that the example memory/storage components are listed in increasing order of access time and capacity, though there are possible exceptions.

A memory controller 110G may be used to handle the protocol and provide the signal interface required of main memory 110D and to schedule memory accesses. The memory controller can be implemented on the processor die or on a separate die. It is to be understood that the memory hierarchy provided above is non-limiting and other memory hierarchies may be used without departing from the scope of this disclosure.

Microprocessor 100 also includes a pipeline, illustrated in simplified form in FIG. 1 as pipeline 102. Pipelining may allow more than one instruction to be in different stages of retrieval and execution concurrently. Put another way, a set of instructions may be passed through various stages included in pipeline 102 while another instruction and/or data is retrieved from memory. Thus, the stages may be utilized while upstream retrieval mechanisms are waiting for memory to return instructions and/or data, engaging various structures such as caches and branch predictors so that other cache misses and/or branch mispredicts may potentially be discovered. This approach may potentially accelerate instruction and data processing by the microprocessor relative to approaches that retrieve and execute instructions and/or data in an individual, serial manner.

As shown in FIG. 1, pipeline 102 includes fetch logic 120, decode logic 122, scheduling logic 124, execution logic 128, runahead entry control logic 130, permissive logic 131, absolute logic 132, and writeback logic 134. Fetch logic 120 retrieves instructions from the memory hierarchy 110, typically from either unified or dedicated L1 caches backed by L2-L3 caches and main memory. Decode logic 122 decodes the instructions, for example by parsing opcodes, operands, and addressing modes. Upon being parsed, the instructions are then scheduled by scheduling logic 124 for execution by execution logic 128.

In some embodiments, scheduling logic 124 may be configured to schedule instructions for execution in the form of instruction set architecture (ISA) instructions. Additionally or alternatively, in some embodiments, scheduling logic 124 may be configured to schedule bundles of micro-operations for execution, where each micro-operation corresponds to one or more ISA instructions or parts of ISA instructions. It will be appreciated that any suitable arrangement for scheduling instructions in bundles of micro-operations may be employed without departing from the scope of the present disclosure. For example, in some embodiments, a single instruction may be scheduling in a plurality of bundles of micro-operations, while in some embodiments a single instruction may be scheduling as a bundle of micro-operations. In yet other embodiments, a plurality of instructions may be scheduling as a bundle of micro-operations. In still other embodiments, scheduling logic 124 may schedule individual instructions or micro-operations, e.g., instructions or micro-operations that do not comprise bundles at all.

As shown in the embodiment depicted in FIG. 1, scheduling logic 124 includes detection logic 126 operative to detect a predetermined instruction category for an instruction retrieved by fetch logic 120. In some embodiments, detection logic 126 may identify an absolute instruction category associated with the retrieved instruction. In some other embodiments, detection logic 126 may identify a permissive instruction category associated with the retrieved instruction. It will be appreciated that virtually any predetermined category may be detected by detection logic 126.

The detected category may be used to determine one or more runahead policies governing how the microprocessor is to be operated while executing the associated instruction in runahead, as explained in more detail below. It will be appreciated that detection logic 126 may detect instruction categories during any suitable portion of microprocessor operations. For example, in some embodiments, detection logic 126 may detect instruction categories without regard to whether microprocessor 100 is operating in runahead mode. In such embodiments, microprocessor 100 may be able to apply appropriate runahead policies to instructions even after those instructions have been issued for execution. In some other embodiments, detection logic 126 may be configured to detect instruction categories during runahead mode alone.

While FIG. 1 shows detection logic 126 as included in scheduling logic 124, it will be appreciated that detection logic 126 may be included in any suitable portion of microprocessor 100. For example, writeback logic 134 may include suitable detection logic 126. Moreover, it will be appreciated that various functions of detection logic 126 may be distributed among more than one portion of microprocessor 100. For example, scheduling logic 124 may include detection logic 126 configured to detect permissive instruction categories while writeback logic 134 may include detection logic 126 configured to detect absolute instruction categories.

As shown in FIG. 1, the depicted embodiment of pipeline 102 includes execution logic 128 that may include one or more execution mechanism units configured to execute instructions issued by scheduling logic 124. Any suitable number and type of execution mechanism units may be included within execution logic 128. Non-limiting examples of execution mechanism units that may be included within execution logic 128 include arithmetic processing units, floating point processing units, load/store processing units, jump stats/retirement units, and/or integer execution units.

The embodiment of microprocessor 100 shown in FIG. 1 depicts runahead control logic 130. Runahead control logic 130 controls entry to and exit from runahead mode for microprocessor 100. For example, in the example shown in FIG. 1, runahead control logic 130 signals permissive logic 131 and absolute logic 132 that the microprocessor is in runahead upon detection of a runahead-triggering event. In turn, permissive logic 131 and absolute logic 132 may take action by applying one or more runahead policies to instructions that will be issued during runahead.

In some embodiments, permissive logic 131 and absolute logic 132 may communicate with pipeline 102 and runahead control logic 130 so that respective runahead policies may be implemented at different stages of pipeline 102. In turn, a permissive runahead policy may be applied earlier in pipeline 102 than an absolute runahead policy on entry into runahead. For example, permissive logic 131 may instruct scheduling logic 124 to apply a permissive runahead policy to an instruction prior to issuance during runahead. In turn, execution of that instruction may be enhanced in runahead as a result of power and/or performance management actions taken by microprocessor 100 when executing the instruction. As another example, absolute logic 132 may instruct writeback logic 134, configured to commit the results of execution operations to an appropriate location (e.g., register 109), to prevent one or more writeback actions during runahead. In turn, writeback logic 134 may prevent cache corruption that may result from alteration during runahead, as described below.

In some embodiments, runahead control logic 130 may also control memory operations related to entry and exit from runahead. For example, on entry to runahead, portions of microprocessor 100 may be checkpointed to preserve the state of microprocessor 100 while a non-checkpointed working state version of microprocessor 100 speculatively executes instructions during runahead. Non-limiting examples of portions of microprocessor 100 that may be checkpointed during runahead include buffers (not shown), registers 109, and states for execution logic 128. In some of such embodiments, runahead control logic 130 may restore microprocessor 100 to the checkpointed state on exit from runahead.

It will be understood that the above stages shown in pipeline 102 are illustrative of a typical RISC implementation, and are not meant to be limiting. For example, in some embodiments, the fetch logic and the scheduling logic functionality may be provided upstream of a pipeline, such as compiling VLIW instructions or code-morphing. In some other embodiments, the scheduling logic may be included in the fetch logic and/or the decode logic of the microprocessor. More generally a microprocessor may include fetch, decode, and execution logic, each of which may comprise one or more stages, with mem and write back functionality being carried out by the execution logic. The present disclosure is equally applicable to these and other microprocessor implementations, including hybrid implementations that may use VLIW instructions and/or other logic instructions.

In the described examples, instructions may be fetched and executed one at a time, possibly requiring multiple clock cycles. During this time, significant parts of the data path may be unused. In addition to or instead of single instruction fetching, pre-fetch methods may be used to enhance performance and avoid latency bottlenecks associated with read and store operations (e.g., the reading of instructions and loading such instructions into processor registers and/or execution queues). Accordingly, it will be appreciated that virtually any suitable manner of fetching, scheduling, and dispatching instructions may be used without departing from the scope of the present disclosure.

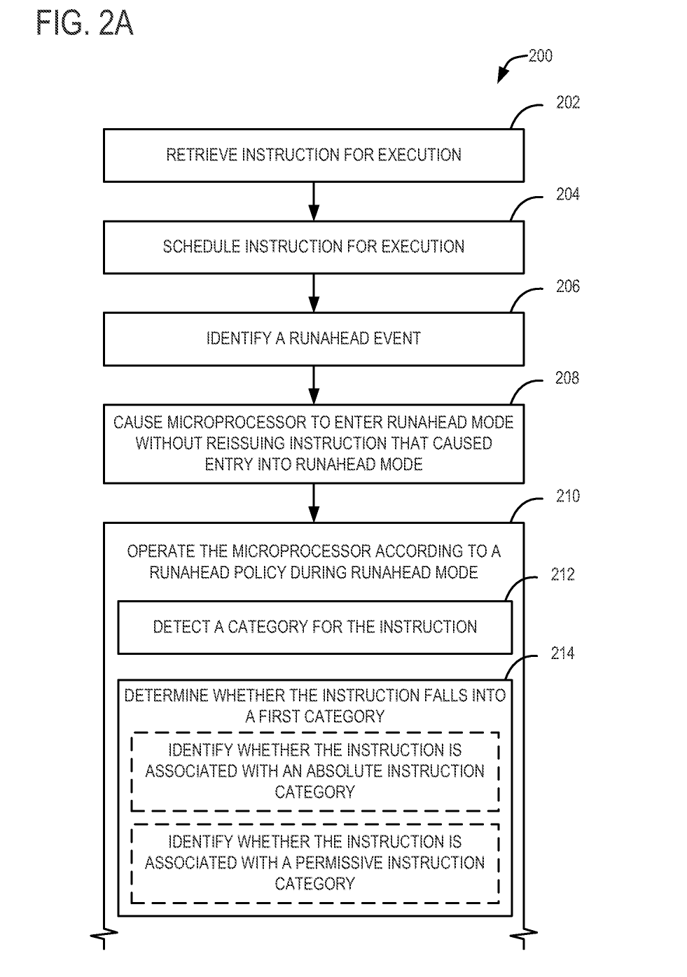

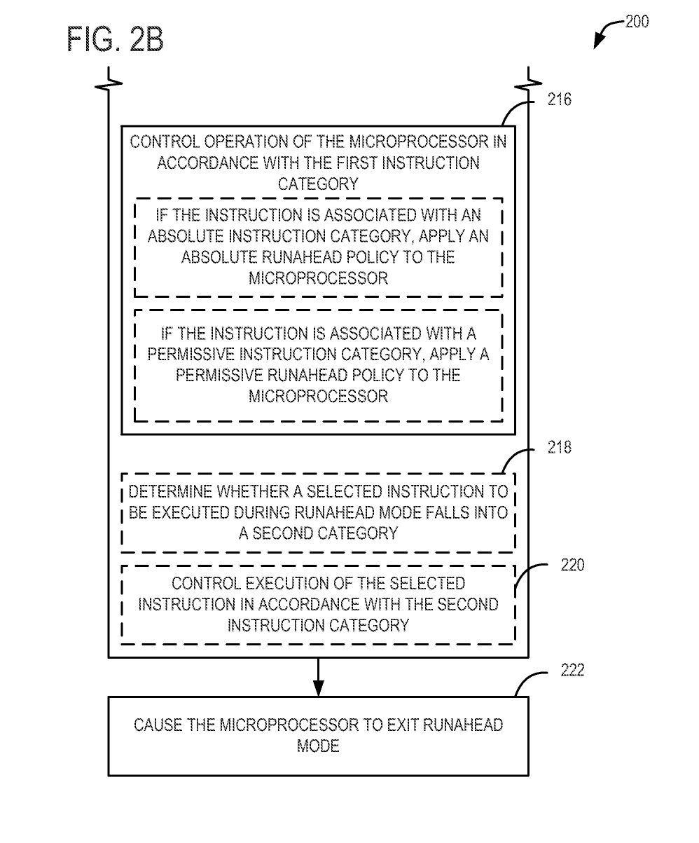

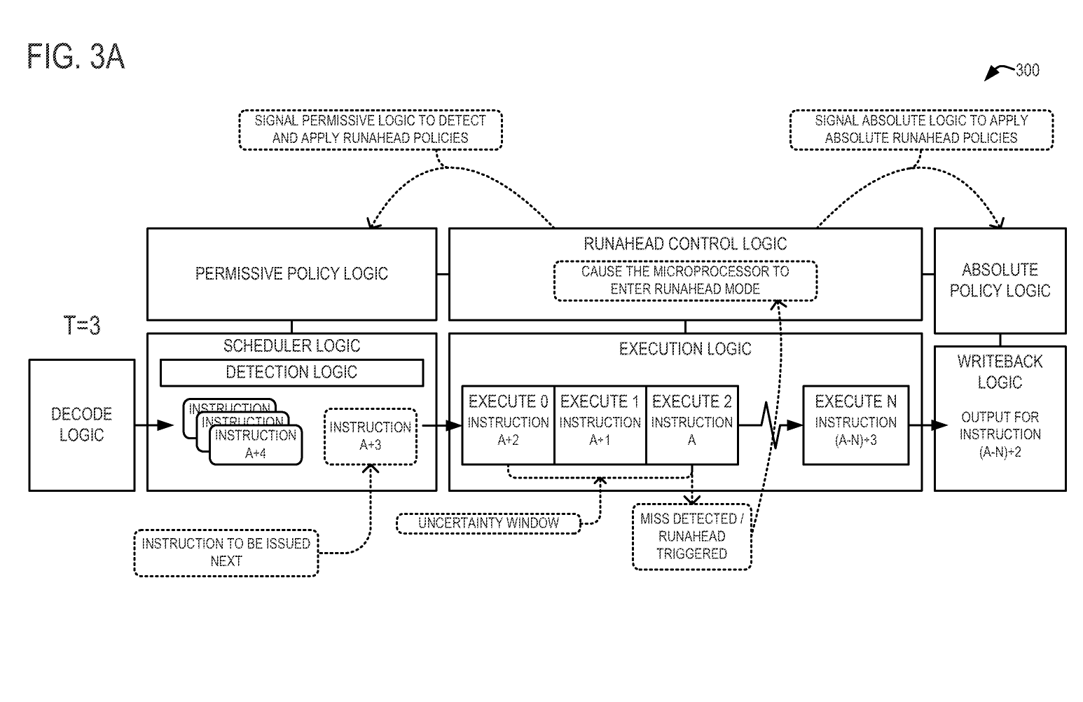

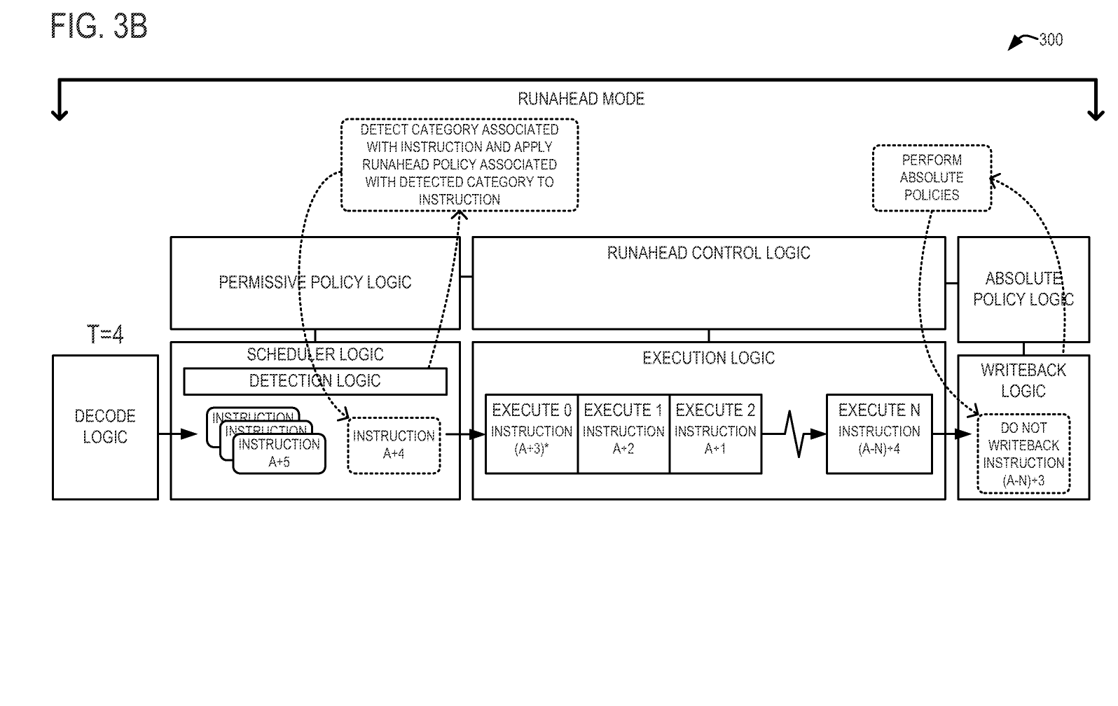

FIGS. 2A and 2B show an embodiment of a method 200 for causing a microprocessor to enter into and operate in runahead without reissuing the instruction that caused the microprocessor to enter into runahead. For example, in some embodiments, method 200 may be used to operate an in-order microprocessor (e.g., a microprocessor where instructions are executed according to a preselected program order). However, it will be appreciated that embodiments of method 200 may be used to operate any suitable microprocessor in runahead without departing from the scope of the present disclosure. For example, FIGS. 3A and 3B schematically show a portion of an embodiment of microprocessor pipeline 300 at which an embodiment of method 200 may be implemented.

Continuing with FIG. 2A, at 202, method 200 includes retrieving an instruction for execution, and, at 204, scheduling the instruction for execution. At 206, method 200 includes identifying a runahead event, and, at 208, causing the microprocessor to enter runahead without reissuing the instruction that caused entry into runahead.

As an illustrative example of how method 200 may be performed, FIGS. 3A and 3B schematically show an embodiment of a microprocessor pipeline 300 executing a series of instructions. In the example shown in FIGS. 3A and 3B, Instruction A was issued by the scheduling logic at an earlier reference time T=0. At T=3, shown in FIG. 3A, Instruction A triggers a runahead event. Microprocessor pipeline 300 enters runahead and, at T=4, shown in FIG. 3B, dispatches the next instruction for execution (Instruction A+3) without reissuing the instruction that triggered runahead. In some instances, reissuing the instruction triggering runahead may reduce the number of instructions that may be processed in runahead.

For example, because it was not known that Instruction A would trigger entry into runahead prior to issuance, runahead policies are not applied at issuance to Instruction A and all of the instructions issued subsequent to Instruction A, as indicated by an uncertainty window shown in FIG. 3A. If Instruction A were reissued, at least three clock cycles of runahead would be consumed while returning the microprocessor to a runahead-mode version of the current state (e.g., by reissuing Instructions A, A+1, and A+2). However, because only Instruction A triggered runahead during the first three clock cycles, no new information about potential stall conditions for the microprocessor would be uncovered during those three clock cycles. By executing in runahead without reissuing the runahead-triggering instruction, it may be possible that another potential stall condition may be uncovered. The potential advantage of transitioning to runahead without reissuing the runahead-triggering instruction may be greater in situations where a runahead-triggering event occurs deep in the execution logic. In such a situation, were the runahead-triggering instruction reissued, the initial runahead-triggering event might be resolved, and runahead exited, before the runahead-triggering instruction reaches the execution mechanism unit that initially yielded a runahead event.

Continuing with FIG. 2A, after the microprocessor enters runahead at 208, method 200 includes, at 210, operating the microprocessor according to one or more runahead policies during runahead. As used herein, runahead policies refer to any suitable actions that govern operation of the microprocessor during runahead. Implementation of one or more runahead policies may cause the microprocessor to operate differently during runahead than when not in runahead.

For example, runahead policies may cause a microprocessor to treat some instructions differently and take alternative actions regarding those instructions than would otherwise be taken outside of runahead. Moreover, various runahead policies associated with respective instructions may cause the microprocessor to treat the respective instructions differently from one another during runahead. Such differences in treatment may be based on differences among the respective instructions and/or potential consequences to the microprocessor.

In the embodiment shown in FIG. 2A, operating the microprocessor according to one or more runahead policies during runahead at 210 includes, at 212, detecting an instruction category for an instruction, and at 214, determining whether the instruction falls into a first instruction category. In some embodiments, the instruction category may identify one or more runahead policies that describe one or more actions to be performed by the microprocessor during scheduling, execution, and/or retirement of the instruction in the event that a runahead condition is detected. While the actions described herein are generally treated as being positive actions, it will be appreciated that any suitable negative action or inaction during runahead may be considered to be within the scope of the present disclosure. For example, an action may include suspending activity during runahead that might otherwise occur outside of runahead.

As introduced above, some actions may be viewed as having differing relative priorities during runahead, so that some actions may be categorized as being permissive, while other actions may be categorized being absolute. Accordingly, in some embodiments, determining whether an instruction falls into a first category may include identifying whether the instruction is associated with a permissive instruction category. Non-limiting examples of permissive instruction categories include a microprocessor power management instruction category and a microprocessor performance management category. Further, in some embodiments, determining whether an instruction falls into a first category may include identifying whether the instruction is associated with an absolute instruction category. One non-limiting example of an absolute instruction category includes a microprocessor correctness instruction category.

Because the operational stability of the microprocessor may be affected by potential runahead actions, operating the microprocessor according to a runahead policy during runahead at 214 includes, at 216, controlling operation of the microprocessor in accordance with the first instruction category. For example, in some embodiments, scheduling, executing, or retiring the instruction associated with the first instruction category may be controlled according to the first instruction category. Additionally or alternatively, in some embodiments, scheduling, executing, or retiring a different instruction may be controlled according to the first instruction category.

In some embodiments, controlling operation of the microprocessor in accordance with the first instruction category at 216 may include applying a permissive runahead policy to the microprocessor. For example, if the first instruction category is associated with a permissive action, a permissive runahead policy may be applied to the microprocessor.

Application of a permissive runahead policy may enhance microprocessor operation in runahead for some instructions by improving the efficiency with which those instructions may be executed in the pipeline. In the example shown in FIG. 3A, Instruction A+3 is depicted as being the next instruction that may be issued by the scheduling logic at the time the runahead entry condition is triggered. The runahead control logic sends a signal to the permissive logic, which in turn signals the scheduler to detect and apply runahead policies. One clock cycle later (e.g., T=4), when FIG. 3B shows Instruction (A+3)* at execution unit EXECUTE 0, indicating that a permissive runahead policy was applied to Instruction A+3 on issuance from the scheduling logic.

While this example is related to a policy that is performed prior to issuance, it will be appreciated that suitable permissive logic may communicate with the pipeline and/or the execution logic at one or more suitable locations. For example, permissive logic that includes logic related to power and performance management runahead policies may communicate with one or more early stages of the execution logic. Providing additional communication between early stages of the execution logic may permit application of permissive runahead policies to instructions already in the execution logic after runahead is triggered (e.g., within the uncertainty window), potentially providing additional runahead operational efficiency.

As introduced above, permissive runahead policies may lead to more efficient operation of the microprocessor during runahead. In some embodiments, application of a permissive runahead policy may cause the microprocessor to convert a selected instruction from a first type to a second type. Such embodiments may be examples of actions associated with a microprocessor power management instruction category.

For example, application of a permissive runahead policy may cause a floating point operation instruction to be converted to a non-operational instruction. Conversion of a floating point operation instruction to a non-operational instruction may save power and/or time during runahead, as floating point operation instructions typically are not used to compute an address or resolve a branch or otherwise uncover potential stalls and misses during runahead. In some embodiments, application of a permissive runahead policy may cause the microprocessor to poison a destination for a selected instruction. For example, if a floating point operation instruction is converted to a non-operational instruction, an integer instruction that is seeded with floating point data (e.g., an instruction that uses floating point data as input) from the converted instruction will likely yield an invalid result. Poisoning the destination register for the floating point data-seeded instruction (the integer instruction in this example) may reduce potential cache pollution.

In some embodiments, application of a permissive runahead policy may cause the microprocessor to suppress trap or fault conditions for instructions having poisoned source registers. Such embodiments may be examples of actions associated with a microprocessor performance management instruction category. Because traps and faults typically halt microprocessor operation, encountering a trap or fault may shorten time in runahead. Suppressing trap/fault conditions during runahead may enhance microprocessor performance by providing additional opportunities for branches to be resolved and misses to be exposed.

While a microprocessor may take some actions in runahead to enhance operation, in some settings a microprocessor may be required to perform some actions to preserve and protect the functional stability and correctness of the microprocessor. In some embodiments, controlling operation of the microprocessor in accordance with the first instruction category at 216 may include applying an absolute runahead policy to the microprocessor. For example, if the first instruction category is associated with an absolute action, an absolute runahead policy may be applied to the microprocessor to prevent an action that may affect microprocessor correctness.

Because the actions that preserve microprocessor correctness are typically associated with commit, writeback, or other memory operations, such operations often occur near the end of the execution logic. For example, an input/output operation is typically performed late in the execution logic, as are operations that may update or otherwise affect the architectural state of the microprocessor. Thus, the runahead-triggering event is often an instruction that has not reached such operations. In turn, the instructions issued to the execution logic after that instruction are also unlikely to have reached those operations. Accordingly, on detection of runahead, absolute runahead policies may be applied to any instruction that emerges from the execution logic, or to any instruction arriving at an operation that may affect microprocessor correctness, after runahead is detected.

In the example shown in FIG. 3A, the runahead control logic signals the absolute logic to apply absolute runahead policies on detection of the runahead-triggering event. In turn, the absolute logic signals the writeback logic to perform the absolute runahead polices depending upon the instruction identity. For example, in the example shown in FIG. 3B, writeback will be permitted for those instructions preceding the runahead-triggering Instruction A (e.g., Instruction (A−1) and earlier instructions). Absolute runahead policies will be applied to the runahead-triggering Instruction A and Instructions (A+1) and (A+2). While this example is related to a policy that is performed at writeback, it will be appreciated that suitable absolute runahead policies may be performed at any suitable location within the pipeline, such as upon exit from the execution logic or at one or more correctness-related stages within the pipeline.

In some embodiments, application of an absolute runahead policy may cause the microprocessor to prevent alterations to a committed state of the microprocessor during runahead. For example, an absolute runahead policy may prevent updates to a non-checkpointed state of the microprocessor during runahead, potentially facilitating a trusted reversion to the original state after runahead. As another example, an absolute runahead policy may prevent memory operations that may have architectural effects other than those described in the example above from occurring during runahead, such as input/output operations, writeback operations, and the like. In some settings, an absolute runahead policy may prevent alterations to a memory system of the microprocessor that affect the microprocessor architectural state.

It will be appreciated that an instruction may fall into more than one instruction category, so that a plurality of runahead policies may be applied to the instruction as the instruction is executed. For example, permissive and absolute runahead policies may be applied to the instruction during runahead. Thus, in some embodiments, operating the microprocessor according to a runahead policy during runahead at 210 may include, at 218, determining whether that instruction falls into a selected category, and, at 220, controlling execution of that instruction in accordance with the second instruction category. For example, a second suitable runahead policy may be applied to the instruction according to the second instruction category.

Once the condition that caused the microprocessor to enter runahead is resolved, the microprocessor may exit runahead. Thus, method 200 includes causing the microprocessor to exit runahead at 222. Typically, the microprocessor re-enters normal operation by returning to the checkpointed state and reissuing the instruction that triggered runahead.

It will be appreciated that methods described herein are provided for illustrative purposes only and are not intended to be limiting. Accordingly, it will be appreciated that in some embodiments the methods described herein may include additional or alternative processes, while in some embodiments, the methods described herein may include some processes that may be reordered or omitted without departing from the scope of the present disclosure. Further, it will be appreciated that the methods described herein may be performed using any suitable hardware including the hardware described herein.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples as understood by those of ordinary skill in the art. Such other examples are intended to be within the scope of the claims.

1. A microprocessor, comprising:
fetch logic for retrieving an instruction;
scheduling logic for issuing the instruction retrieved by the fetch logic for execution; and
runahead control logic which is operative, in the event that execution of the instruction as scheduled by the scheduling logic produces a runahead-triggering event, to cause the microprocessor to enter into and operate in a runahead mode without reissuing the instruction, and carry out runahead policies while the microprocessor is in the runahead mode that govern operation of the microprocessor and cause the microprocessor to operate differently than when not in the runahead mode.

2. The microprocessor of claim 1, further comprising detection logic for identifying whether a selected instruction is associated with an absolute instruction category or a permissive instruction category during the runahead mode.

3. The microprocessor of claim 2, where the scheduling logic is part of a multi-stage pipeline and where a permissive runahead policy associated with the permissive instruction category is applied earlier in the multi-stage pipeline than is an absolute runahead policy associated with the absolute instruction category.

4. The microprocessor of claim 1, where, for a selected instruction, the runahead control logic is configured to determine whether the selected instruction falls into a first instruction category, and, if the selected instruction falls into the first instruction category, control operation of the microprocessor in accordance with a first runahead policy associated with the first instruction category.

5. The microprocessor of claim 4, where, for the selected instruction, the runahead control logic is further configured to determine whether the selected instruction falls into a second instruction category, and, if the selected instruction falls into the second instruction category, control operation of the microprocessor in accordance with a second runahead policy associated with the second instruction category.

6. The microprocessor of claim 4, where the first runahead policy causes the microprocessor to convert the selected instruction from a first type to a second type during the runahead mode.

7. The microprocessor of claim 4, where the selected instruction is a floating point data-seeded instruction and where the first runahead policy causes the microprocessor to poison a destination for the selected instruction.

8. The microprocessor of claim 4, where the first runahead policy causes the microprocessor to suppress a fault condition associated with a poisoned source register originated by the selected instruction.

9. The microprocessor of claim 4, where the first runahead policy causes the microprocessor to prevent alterations to a microprocessor memory system that affect an architectural state of the microprocessor during the runahead mode.

10. The microprocessor of claim 4, where the first runahead policy causes the microprocessor to prevent an update to a non-checkpointed state of the microprocessor.

11. A method of executing an instruction at a microprocessor, the method comprising:
during execution of the instruction, identifying a runahead event triggered by the execution of the instruction;
upon identification of the runahead event, causing the microprocessor to enter into and operate in a runahead mode without reissuing the instruction and carrying out runahead policies while the microprocessor is in the runahead mode;
operating the microprocessor according to the runahead policies during the runahead mode so that the microprocessor operates differently than when not in runahead mode.

12. The method of claim 11, further comprising:
determining whether a selected instruction falls into a first instruction category, and;
controlling operation of the microprocessor in accordance with a first runahead policy if the selected instruction falls into the first instruction category.

13. The method of claim 12, further comprising:
determining whether the selected instruction occurring during the runahead mode falls into a second instruction category, and;
controlling operation of the microprocessor in accordance with a second instruction policy if the selected instruction falls into the second instruction category.

14. The method of claim 12, where controlling operation of the microprocessor in accordance with a first runahead policy comprises converting the selected instruction from a first type to a second type during the runahead mode according to the first runahead policy.

15. The method of claim 12, where the selected instruction is a floating point data-seeded instruction and where controlling operation of the microprocessor in accordance with a first runahead policy comprises causing the microprocessor to poison a destination for a floating point data-seeded instruction.

16. The method of claim 12, where controlling operation of the microprocessor in accordance with a first runahead policy comprises causing the microprocessor to suppress a fault condition associated with a poisoned source register originated by the selected instruction.

17. The method of claim 12, where controlling operation of the microprocessor in accordance with a first runahead policy comprises preventing alterations to a microprocessor memory system that affect an architectural state of the microprocessor during the runahead mode.

18. The method of claim 12, where controlling operation of the microprocessor in accordance with the first runahead policy comprises preventing an update to a non-checkpointed state of the microprocessor.

19. A microprocessor, comprising:
fetch logic for retrieving an instruction for execution;
detection logic for detecting a particular instruction category from a plurality of instruction categories for the instruction retrieved by the fetch logic; and
runahead control logic which is operative, in the event that execution of the instruction produces a runahead-triggering event, to (i) cause the microprocessor to enter into and operate in a runahead mode without reissuing the instruction and (ii) to identify a runahead policy that governs operation of the microprocessor with reference to the particular instruction category.

20. The microprocessor of claim 19, further comprising a multi-stage pipeline, where the plurality of instruction categories includes a permissive instruction category and an absolute instruction category, and where a permissive runahead policy associated with the permissive instruction category is applied earlier in the multi-stage pipeline than is an absolute runahead policy associated with the absolute instruction category.
